(19) United States
(12) Patent Application Publication
(10) Pub. No.: US 2026/0219979 A1
(43) Pub. Date: Jul. 30, 2026

(54) FAULT DETECTION AND ERROR REDUCTION IN SYSTOLIC ARRAY

(71) Applicants: Sanghamitra Roy, Logan, UT (US); Koushik Chakraborty, Logan, UT (US); Noel Daniel Gundi, Logan, UT (US)

(72) Inventors: Sanghamitra Roy, Logan, UT (US); Koushik Chakraborty, Logan, UT (US); Noel Daniel Gundi, Logan, UT (US)

(73) Assignee: Utah State University, Logan, UT (US)

(21) Appl. No.: 19/040,634

(22) Filed: Jan. 29, 2025

(51) Int. Cl. G06F 11/07

(52) U.S. Cl. CPC G06F 11/079; G06F 11/0721; G06F 11/0793

(57) ABSTRACT

For detecting faults and reducing errors, a multiply accumulator (MAC) includes an activation register that receives a next activation and outputs a current activation. The MAC further includes a weight register that stores a weight. The MAC includes an accumulator that multiplies the weight and the current activation to generate a MAC product. The MAC includes a control unit that outputs a previous MAC output as a MAC output in response to a zero condition comprising a zero weight else outputs the MAC sum as the MAC output in response to no zero condition.

### FEDERALLY SPONSORED RESEARCH AND DEVELOPMENT

This invention was made with government support under grant number CNS2106237 awarded by the National Science Foundation. The government has certain rights in the invention.

### BACKGROUND INFORMATION

The subject matter disclosed herein relates to fault detection and error reduction and more particularly relates to fault detection and error reduction in a systolic array.

### BRIEF DESCRIPTION

A multiply accumulator (MAC) is disclosed that detects faults and reduces errors. The MAC includes an activation register that receives a next activation and outputs a current activation. The MAC further includes a weight register that stores a weight. The MAC includes an accumulator that multiplies the weight and the current activation to generate a MAC product. The MAC includes a control unit that outputs a previous MAC output as a MAC output in response to a zero condition comprising a zero weight else outputs the MAC sum as the MAC output in response to no zero condition. A semiconductor and method are also disclosed.

### BRIEF DESCRIPTION OF DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of semiconductor;

FIG. 2A is a schematic block diagram illustrating one embodiment of a MAC;

FIG. 2B is a schematic block diagram illustrating one alternate embodiment of a MAC;

FIG. 2C is a schematic block diagram illustrating one embodiment of a control unit;

FIG. 2D is a schematic block diagram illustrating one alternate embodiment of a control unit;

FIG. 2E is a schematic block diagram illustrating one alternate embodiment of a MAC;

FIG. 3 is a schematic block diagram illustrating one embodiment of system data;

FIG. 4A is a schematic block diagram illustrating one embodiment of a systolic array;

FIG. 4B is a schematic block diagram illustrating one embodiment of a systolic array with faults;

FIG. 5A is a schematic flow chart diagram illustrating one embodiment of an error resilience method; and

FIG. 5B is a schematic flow chart diagram illustrating one embodiment of a fault correction method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may be referred to herein as a “circuit,” “module,” or “system.” Furthermore, aspects of the present invention may take the form of a computer program product embodied in one or more computer readable medium(s) having program code embodied thereon.

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

Program code for carrying out operations for aspects of the present invention may be written in any combination of one or more programming languages, including an object-oriented programming language such as MATLAB, Python, Ruby, R, Java, Java Script, Julia, Smalltalk, C++, C sharp, Lisp, Go, Clojure, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The computer program product may be shared, simultaneously serving multiple customers in a flexible, automated fashion.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

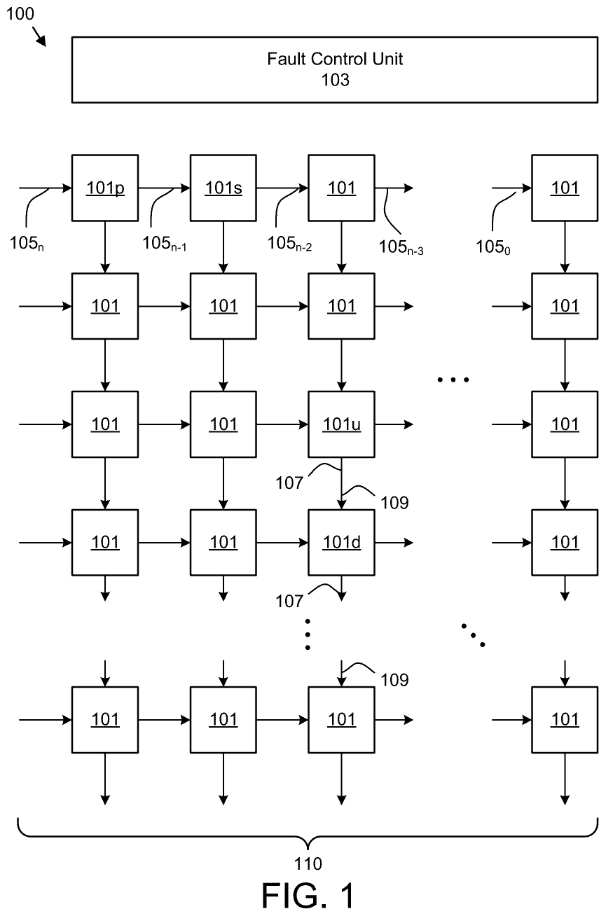

FIG. 1 is a schematic block diagram illustrating one embodiment of semiconductor 100. The semiconductor 100 may be fabricated on one or more semiconductor dies. In the depicted embodiment, the semiconductor 100 comprises a systolic array 110 of MACs 101. Each MAC 101 receives a next activation 105 as an input. The next activation 105 may be from a precedent MAC 101p. In addition, an input next activation 105n may be loaded into the systolic array 110. A MAC 101 outputs a current activation 105 to a subsequent MAC 101s. To illustrate the relationship of precedent MACs 101p and subsequent MACs 101s, two MACs 101 are so labeled. However, a given MAC 101 may be a subsequent MAC 101s to a precedent MAC 101p as well as a precedent MAC 101p to a subsequent MAC 101s. The MACs 101 that received the input next activation 105n do not have a precedent MAC 101p. Similarly, some MACs 101 do not output the current activation 105 to subsequent MACs 101s as shown.

In the depicted embodiment, exemplary MACs 101 are labeled as an upstream MAC 101u and a downstream MAC 101d. A downstream MAC 101d may receive a previous Mac output 109. An upstream MAC 101u may output a Mac output 107. The Mac output 107 of the upstream MAC 101u is the same as the previous Mac output 109 of the downstream MAC 101d.

In one embodiment, each MAC 101 performs a multiply accumulate operation as will be described hereafter. The MAC 101 may multiply the next activation 105 by a weight and sum the product of the multiplication with the previous Mac output 109 to generate the Mac output 107 as will be described hereafter.

The propagation of activations 105 and Mac outputs 107 are subject to delays. In addition, computations and the propagation of activations 105 and Mac outputs 107 are controlled by clock signals (clocks) that propagate through the semiconductor 100 and are also subject to delays. A delay in a clock, computation, activation 105 and/or Mac output 107 will cause in an error in the result calculated by the systolic array 110.

Delays may be caused by voltage variations within the semiconductor 100, fabrication inconsistencies, and the like. The use of some fabrication technologies such as low-power computing (LPC) can further exacerbate potential delays. The delays can result in occasional errors at MACs 101. The embodiments described herein mitigate errors caused by delays due to voltage variations and other transient effects. In addition, fabrication irregularities may result in persistent and/or regular errors at specific MACs 101. The embodiments also mitigate errors due to persistent faults such as from fabrication irregularities. In the depicted embodiment, a fault control unit 103 is shown. The embodiments may detect persistent faults in MACs 101 and record the persistent faults in the fault control unit 103. The fault control unit 103 may then mitigate the persistent faults as will be described hereafter.

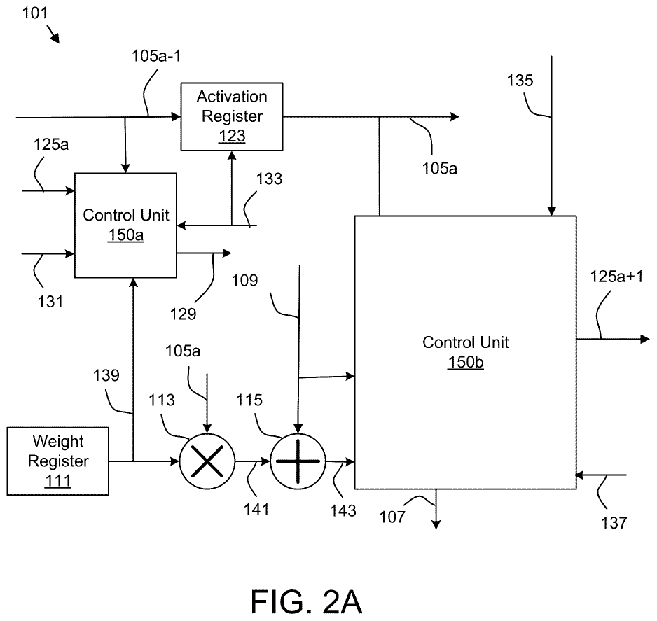

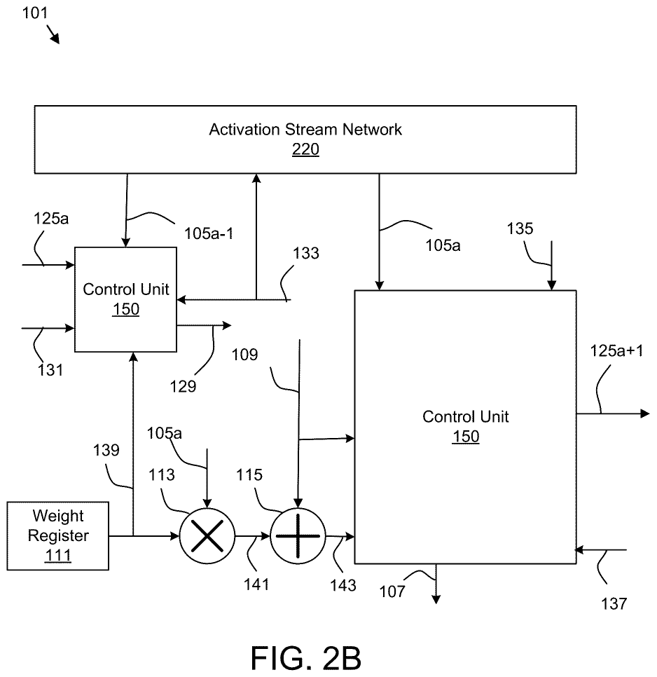

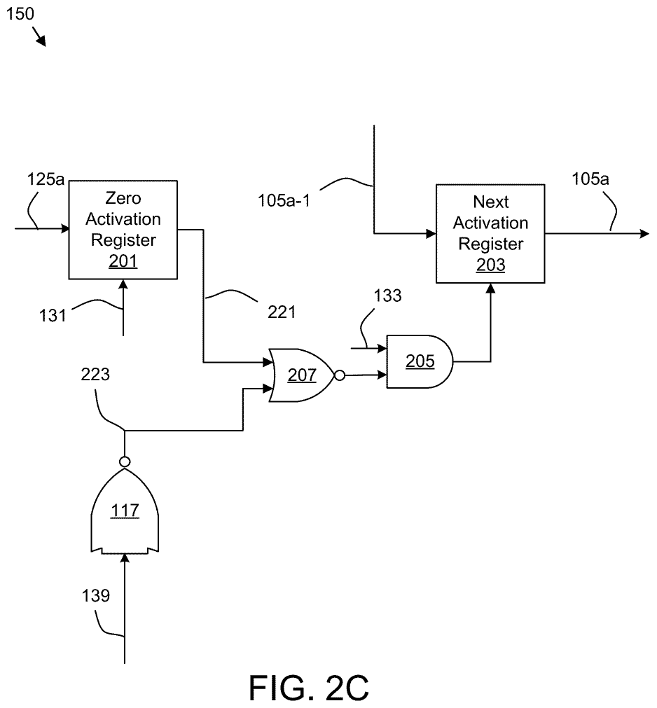

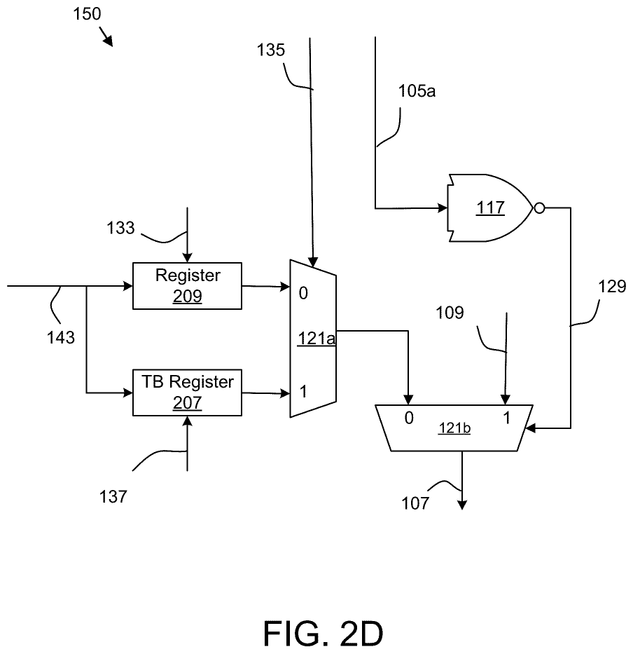

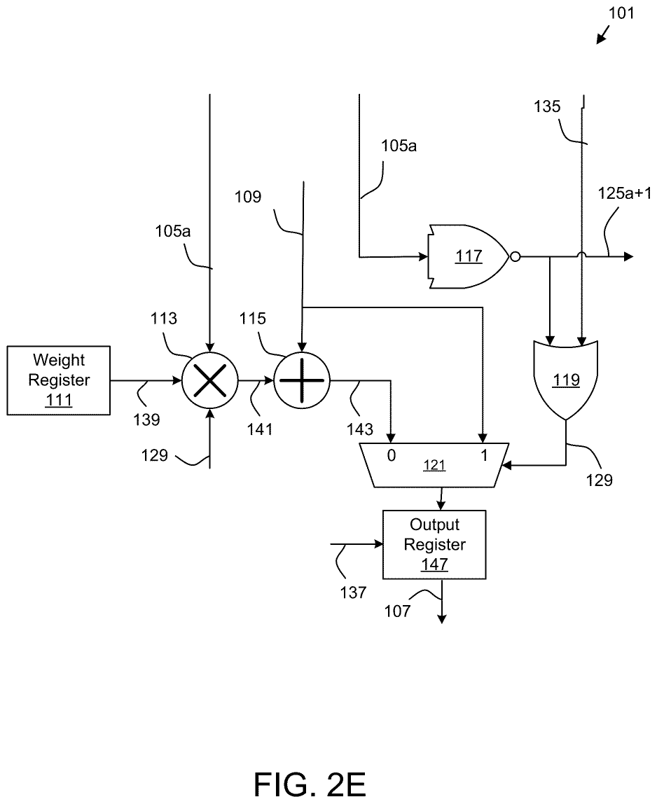

FIG. 2A is a schematic block diagram illustrating one embodiment of a MAC 101. The MAC 101 may be fabricated of semiconductor gates, diodes, capacitors, and the like. In one embodiment, the MAC 101 and/or semiconductor 100 is fabricated using LPC fabrication technologies. In the depicted embodiment, the MAC 101 receives the next activation 105a−1. The next activation 105a−1 may be stored in an activation register 123 in response to a system clock 133. The activation register 123 may be a flip-flop, a register, and the like. A current activation 105a is available from the activation register 123.

A control unit 150 receives the next activation 105a−1, the current activation 105a, and a weight 139. A weight 139 may be stored in a weight register 111. The MAC 101 may multiply the current activation 105a and the weight 139 with a multiplier 113 to generate a MAC product 141. The MAC 101 may further sum the Mac product 141 and the previous Mac output 109 with an accumulator 115 to generate a MAC sum 143.

In a prior art MACs 101, the MAC sum 143 is output as the MAC output 107. To mitigate errors, the embodiments select between the MAC sum 143 and the previous MAC output 109 for output as the MAC output 107 based on an asserted zero condition 129. The zero condition 129 may be asserted in response to a weight 139 equal to zero. In one embodiment, the MAC sum 143 is output as the MAC output 107 in response to no asserted zero condition 129. However, in response to an asserted zero condition 129, the control unit 150 outputs the previous MAC output 109 as the MAC output 107.

In one embodiment, the zero condition 129 is asserted in response to receiving an asserted zero activation 125a. The asserted zero activation 125a may be received from a precedent MAC 101p. The zero activation 125a is asserted by a control unit 150 of the precedent MAC 101p in response to a current activation 105a with a value of zero. The current activation 105a of the precedent MAC 101p is the next activation 105a−1 of the illustrated MAC 101. The zero activation 125a is stored to be evaluated concurrently by the illustrated MAC 101 when the current activation 105a of the precedent MAC 101p is the current activation 105a of the illustrated MAC 101. If the current activation 105a is zero, the control unit 150 further asserts the zero activation 105a+1 for a subsequent MAC 101s.

The control unit 150 further receives a fault detection 135. The fault detection 135 may be received from the fault control unit 103. In one embodiment, the zero condition 129 is asserted in response to an assertion of the fault detection 135.

The zero condition 129 may be asserted in response to at least one condition. In addition, the zero condition 129 may be asserted in response combinations of conditions, Table 1 lists conditions that may result in an asserted zero condition 129.

TABLE 1

weight 139 of zero
Zero activation 125 asserted in response to activation 105 of zero
Fault detection 135 asserted

In one embodiment, least significant values of the weight 139 and/or the current activation 105a are set to zero in response to the zero condition 129. The least significant values in the range of one to 16 least significant values of the weight 139 and/or the current activation 105a may be set to zero prior to multiplication by the multiplier 113. By setting the least significant values to zero, the propagation delay of the multiplier 113 is reduced, mitigating delays such as from voltage variability in the MAC 101 and enhancing reliability and error resilience of the MAC 101.

The control unit 150 may further receive the system clock 133, a clock gate clock 131, and a time borrow clock 137. The generation of the clock gate clock 131 and the time borrow clock 137 is described hereafter.

FIG. 2B is a schematic block diagram illustrating one alternate embodiment of a MAC 101. In the depicted embodiment, the MAC 101 of FIG. 2A is shown with an activation stream network 220 providing the next activation 105a−1 and the current activation 105a. The activation register 123 may be embedded in the activation stream network 220. The activation stream network 220 may comprise a plurality of activation registers 123. The activation stream network 220 may comprise at least one activation register 123 for each MAC 101.

FIG. 2C is a schematic block diagram illustrating one embodiment of a control unit 150. The control unit 150 may be embodied in a first control unit 150a of FIGS. 2A-B. The control unit 150 may perform functions which are not shown. In the depicted embodiment, the zero activation 125a is latched in the zero activation register 201 by the clock gate clock 131. The clock gate clock 131 may be delayed from the system clock 133. The clock gate clock 131 may be delayed in the range of 0-60 percent from the system clock 133. In one embodiment, the clock gate clock 131 may be delayed 50 percent from the system clock 133.

In the depicted embodiment, the NOR output 223 of a NOR gate 117 is asserted if the weight 139 is zero. The next activation 125a−1 is latched in the next activation register 203 based on the system clock 133, the latched zero activation 221, and the NOR output 223. As a result, the latching of the next activation 125a−1 may be delayed to mitigate the effects of other delays within the semiconductor 100, enhancing the reliability and error resilience of the MAC 101 and the systolic array 110.

FIG. 2D is a schematic block diagram illustrating one alternate embodiment of a control unit 150. The control unit 150 may be embodied in the second control unit 150a of FIGS. 2A-B. The control unit 150 may perform functions which are not shown.

In the depicted embodiment, the MAC sum 143 is latched in a register 209 by the system clock 133. The MAC sum 143 may also be latched in a time borrow register 207 by the time borrow clock 137. The time borrow clock 137 may be delayed from the system clock 133. The time borrow clock 137 may be delayed in the range of 0-60 percent from the system clock 133. In one embodiment, the time borrow clock 137 may be delayed 50 percent from the system clock 133.

In one embodiment, if the fault detection 135 is asserted for the MAC 101, the MAC sum 143 is selected by a first multiplexer (MUX) 121a from the time borrow register 207. As a result, delays of the MAC sum 143 are mitigated as more time passes before the MAC sum 143 is latched in the time borrow register 207. Thus, the reliability of the MAC 101 is improved. If the fault detection 135 is not asserted, the MAC sum 143 is selected by the first MUX 121a from the register 209.

In one embodiment, if the next activation 105a is zero, a second MUX 121b selects the previous MAC output 109 as the MAC output 107. Otherwise, the MAC sum 143 from the first MUX 121a is output as the MAC output 107. In the depicted embodiment, a NOR gate 117 generates the zero condition 129 from the current activation 105a. As a result, if the current activation 105a is zero, the previous MAC output 109 is always output as the MAC output 107. Because outputting the previous MAC output 109 is less affected by delays than the MAC sum 143, the reliability and error resilience of the MAC 101 is enhanced.

FIG. 2E is a schematic block diagram illustrating one alternate embodiment of a MAC 101. In the depicted embodiment, the zero condition 129 is generated in response to either a current activation 105a of zero or an asserted fault detection 135. If the zero condition 129 is asserted, a MUX 121 selects the previous MAC output 109 as the MAC output 107.

In one embodiment, the output of the NOR gate 117 is output as the zero activation 125a+1 for a subsequent MAC 101s.

In one embodiment, the output of the MUX 121 is latched in an output register 147. The output of the MUX 121 and/or MAC output 107 may be latched with the time borrow clock 137. Because the time borrow clock 137 is delayed from the system clock 133, the output of the MUX 121 and/or MAC output 107 is less susceptible to delays, improving the reliability and error resilience of the MAC 101.

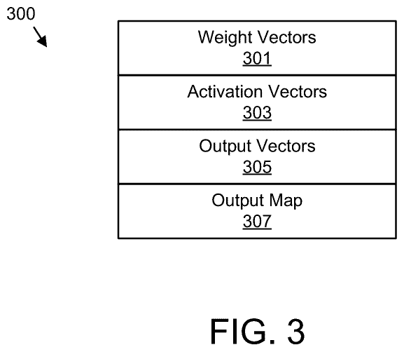

FIG. 3 is a schematic block diagram illustrating one embodiment of system data 300. The system data 300 may be organized as a data structure in memory and/or registers of the semiconductor 100. In the depicted embodiment, the system data 300 includes weight vectors 301, activation vectors 303, output vectors 305, and an output map 307.

The weight vectors 301 comprise the weights 139 that are stored in the weight registers 111 for calculations. The activation vectors 303 comprise the activations 105 for the calculations. The output vectors 305 comprise the results of the calculations for specified weight vectors 301 and activation vectors 303. The results of the calculations may be the MAC outputs 107. The output map 307 comprises expected MAC outputs 107 for a specified calculation.

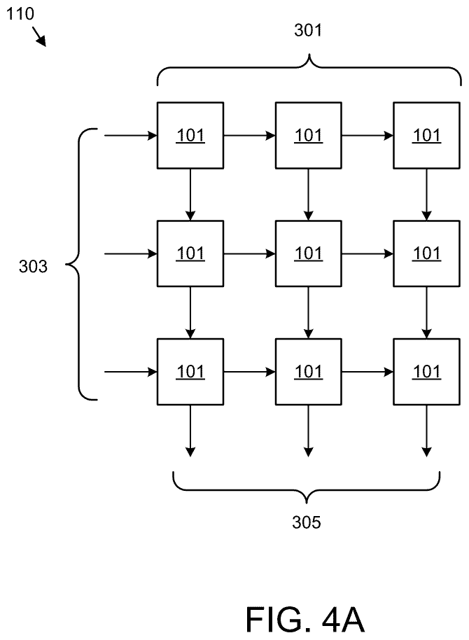

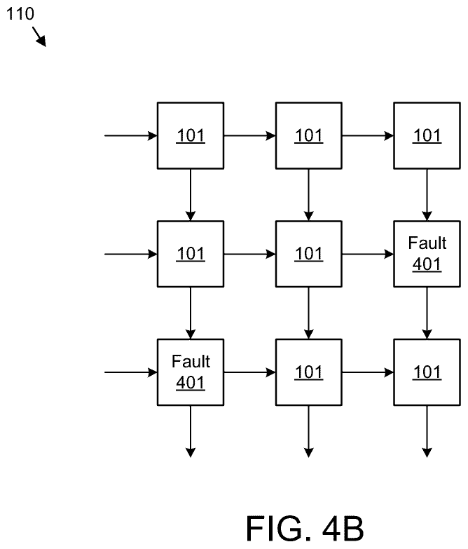

FIG. 4A is a schematic block diagram illustrating one embodiment of a systolic array 110. A simplified 3×3 systolic array 110 is used as an example of fault detection in FIGS. 4A-B but is not limiting. In one embodiment, a calculation is performed by the semiconductor using specified weights 139 of a weight vector 301 and specified activations 105 of an activation vector 303. The output vectors 305 from the calculation are compared with the output map 307 to identify fault detections 135.

FIG. 4B is a schematic block diagram illustrating one embodiment of the systolic array 110 of FIG. 4A with faults. In the depicted embodiment, faults 401 are identified for two MACs 101. The faults 401 may be indicative of persistent faults. In response to the faults 401, the fault detections 135 for the two MACs 101 with faults 401 may be set. The fault detections 135 may be stored in the fault control unit 103. During subsequent calculations, the fault detections 135 are asserted for the two MACs 101 with faults 401, mitigating errors from the faulty MACs 101 and enhancing error resilience.

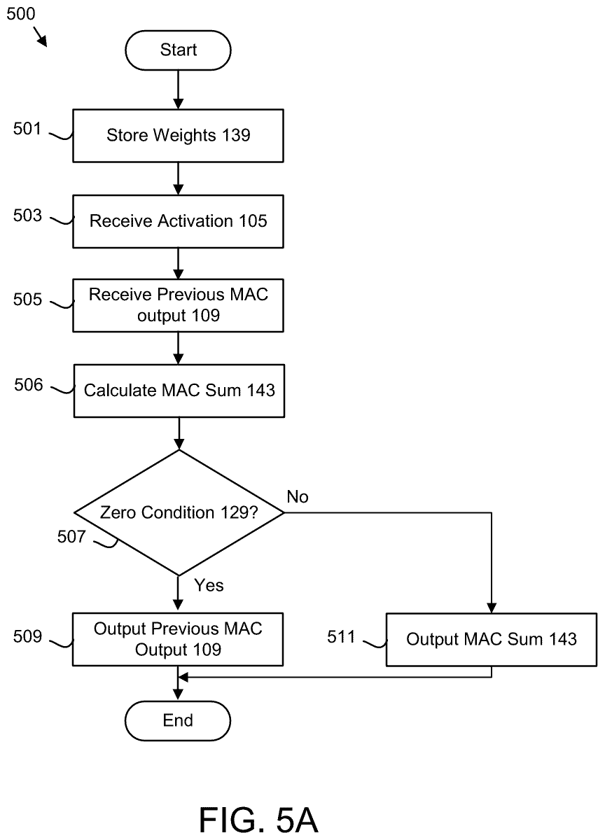

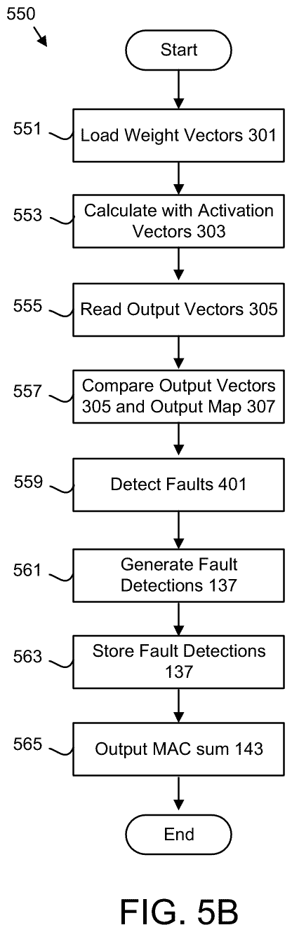

FIG. 5A is a schematic flow chart diagram illustrating one embodiment of an error resilience method 500. The method 500 enhances error resilience in a semiconductor 100. The method 500 may be performed by at least one MAC 101 of the semiconductor 100.

The method 500 starts, and stores 501 weights 139 in the weight registers 111. The weights 139 may be stored 501 from a weight vector 301. The method 500 further receives 503 a next activation 105a−1. The next activation 105a−1 may be received initially from an activation vector 303 and propagate through the systolic array 110. The next activation 105a−1 may also be received from an activation register 123, a precedent MAC 101p, and/or an activation stream network 220. In addition, the method 500 may output a current activation 105a.

The method 500 receives 505 a previous MAC output 109. The previous MAC output 109 may be received 505 from an upstream MAC 101u. In addition, the method 500 calculates 506 the MAC sum 143 by multiplying the weight 139 and the current activation 105a to generate the MAC product 141 and adding the previous MAC output 109 to the MAC product 141 to generate the MAC sum 143. In one embodiment, the least significant bits of the weight 139 and the current activation 105a are set to zero to reduce delays if the zero condition 129 is asserted.

The method 500 determines 507 if the zero condition 129 is asserted. If the zero condition 129 is asserted, the method 500 outputs 509 the previous MAC output 109 as the MAC output 107. The MAC output 107 may be output 509 to a downstream MAC 101d. If the zero condition 129 is not asserted, the method 500 outputs 511 the MAC sum 143 as the MAC output 107.

FIG. 5B is a schematic flow chart diagram illustrating one embodiment of a fault correction method 550. The method 550 corrects faults in a semiconductor 100. The method 550 may be performed by at least one MAC 101 and the fault control unit 103 of the semiconductor 100.

The method 550 starts and loads 551 the weight vectors 301 for a specified calculation. The specified calculation may include the weight vectors 301, corresponding activation vectors 303, and an output map 307. The output map 307 comprises the expected results for the specified calculation. The method 550 further calculates 553 the specified calculation with the activation vectors 303. The method 550 reads 555 the output vectors 305 for the specified calculation and compares 557 the output vectors 305 and the output map 307.

The method 550 detects 559 faults 401 from differences in the output vector 305 and the output map 307. The method 550 generates 561 the fault detections 135 for each MAC 101 with a fault 401. The fault detection 135 is generated in response to a difference between the MAC output 107 in an output vector 305 calculated using the MAC 101 from weight vectors 301 and activation vectors 303, and an expected MAC output 107 from an output map 307 for the weight vectors 301 and the activation vectors 303. The method 550 may store 563 the fault detection 135 in the fault correction unit 103.

In response to the fault detection 135, the MAC 101 outputs 565 the previous MAC output 109 as the MAC output 107 until the fault detection 135 is reset. In one embodiment, least significant values of the weight 139 and the current activation 105a are set to zero in response to the fault detection 135.

Detecting 559 the faults 401 and generating 561 the fault detections 137 may mitigate persistent faults in the systolic array 110 as the function of fault prone MACs 101 is scaled back, mitigating errors.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A multiply accumulator (MAC) comprising:
an activation register that receives a next activation and outputs a current activation;
a weight register that stores a weight;
a multiplier that multiplies the weight and the current activation to generate a MAC product;
an accumulator that adds the MAC product to a previous MAC output to generate a MAC sum; and
a control unit that outputs a previous MAC output as a MAC output in response to a zero condition comprising a zero weight else outputs the MAC sum as the MAC output in response to no zero condition.

2. The MAC of claim 1, the zero condition further comprising a zero activation for a current activation of zero.

3. The MAC of claim 2, wherein the zero activation is received from a precedent MAC.

4. The MAC of claim 2, wherein the zero activation is latched with a clock gate clock delayed from the system clock.

5. The MAC of claim 1, the zero condition further comprising a fault detection.

6. The MAC of claim 5, wherein the fault detection is generated in response to a difference between the MAC output in an output vector calculated using the MAC from weight vectors and activation vectors, and an expected MAC output from an output map for the weight vectors and the activation vectors, the fault detection is further stored in a fault correction unit, and the MAC outputs the MAC sum as the MAC output until the fault detection 135 is reset.

7. The MAC of claim 1, wherein the MAC sum is latched in an output register with a time borrow clock delayed from the system clock.

8. The MAC of claim 1, wherein least significant values of the weight and the current activation are set to zero in response to a fault detection.

9. The MAC of claim 1, wherein the activation register is embedded in an activation stream network comprising a plurality of activation registers.

10. The MAC of claim 1, wherein the MAC is fabricated using low-power computing technologies.

11. A semiconductor comprising:
a systolic array of multiply accumulators (MAC);
a fault correction unit storing a fault detection for each MAC;
wherein each MAC comprises:
an activation register that receives a next activation and outputs a current activation;
a weight register that stores a weight;
a multiplier that multiplies the weight and the current activation to generate a MAC product;
an accumulator that adds the MAC product to a previous MAC output to generate a MAC sum; and
a control unit that outputs a previous MAC output as a MAC output in response to a zero condition comprising a zero weight else outputs the MAC sum as the MAC output in response to no zero condition.

12. The semiconductor of claim 11, the zero condition further comprising a zero activation for a current activation of zero.

13. The semiconductor of claim 12, wherein the zero activation is received from a precedent MAC.

14. The semiconductor of claim 12, wherein the zero activation is latched with a clock gate clock delayed from the system clock.

15. The semiconductor of claim 11, the zero condition further comprising a fault detection.

16. The semiconductor of claim 15, wherein the fault detection is generated in response to a difference between the MAC output in an output vector calculated using the MAC from weight vectors and activation vectors, and an expected MAC output from an output map for the weight vectors and the activation vectors, the fault detection is further stored in a fault correction unit, and the MAC outputs the MAC sum as the MAC output until the fault detection 135 is reset.

17. The semiconductor of claim 11, wherein the MAC sum is latched in an output register with a time borrow clock delayed from the system clock.

18. The semiconductor of claim 11, wherein least significant values of the weight and the current activation are set to zero in response to a fault detection.

19. The semiconductor of claim 11, wherein the activation register is embedded in an activation stream network comprising a plurality of activation registers.

20. A method comprising:
storing a weigh in a weight register of a multiplier accumulator (MAC);
receiving a next activation at an activation register of the MAC and outputting a current activation;
calculating the MAC sum by multiplying the weight and the current activation with a multiplier to generate a MAC product and adding the previous MAC output to the MAC product to generate the MAC sum; and
outputting the previous MAC output as a MAC output in response to a zero condition comprising a zero weight else outputting the MAC sum as the MAC output in response to no zero condition.
